(19) United States
(12) Patent Application Publication
(10) Pub. No.: US 2012/0063918 A1
(43) Pub. Date: Mar. 15, 2012

(54) APPARATUS AND METHOD FOR DETERMINING CLEARANCE OF MECHANICAL BACK-UP BEARINGS OF TURBOMACHINERY UTILIZING ELECTROMAGNETIC BEARINGS

(75) Inventors: Paul de Larminat, Nantes (FR); Damien Jean Daniel Arnou, La Seguiniere (FR)

(73) Assignee: JOHNSON CONTROLS TECHNOLOGY COMPANY, Holland, MI (US)

(21) Appl. No.: 13/321,744

(22) PCT Filed: Jul. 22, 2010
(86) PCT No.: PCT/US2010/042853

§ 371 Date: Nov. 21, 2011

Related U.S. Application Data
(60) Provisional application No. 61/227,467, filed on Jul. 22, 2009.

(51) Int. Cl. F04B 49/00; G01M 13/04

(52) U.S. Cl. 417/1; 324/207.25

(57) ABSTRACT

Apparatus and method for determining the clearance and wear of mechanical back-up bearings of turbomachinery utilizing electromagnetic bearings. In order to reduce the prospects of catastrophic failure during a shut-down or loss of electrical power, a rotating apparatus utilizes the electromagnetic bearings to manipulate the shaft to measure the clearance of the mechanical back-up bearings. When power is restored, a programmable controller provides power to the electromagnetic bearings to automatically move the shaft in accordance with a predetermined sequence to contact the mechanical back-up bearings to determine the clearance of the mechanical back-up bearings. These values are stored in the controller memory. The measured clearance is compared to prior clearance measurements of the mechanical back-up bearings to determine the wear of the back-up bearings. The actual wear is compared to the allowable wear for the bearings. If actual wear exceeds a predetermined value, a warning is generated. If the actual wear equals or exceeds the allowable wear, the controller automatically locks the turbomachinery from further operation until repair or replacement is accomplished. Otherwise, the controller centers the shaft to permit normal operation of the turbomachinery.

### FIELD OF THE INVENTION

The process and apparatus set forth herein generally relates to rotating apparatus having bearings utilizing active magnetic technology to support a rotating shaft, and more specifically to an automated procedure for measuring wear to determine whether to service mechanical safety bearings in the rotating apparatus.

### BACKGROUND OF THE INVENTION

Active magnetic technology in the form of electromagnetic bearings is currently utilized in some turbomachinery, such as motors, compressors or turbines, to reduce friction while permitting free rotational movement by levitating rotors and shafts during operation. Electromagnetic bearings replace conventional technologies like rolling element bearings or fluid film bearings in the operation of such rotating apparatus, but require centering of the shaft within the electromagnetic bearings, the shaft comprising a ferromagnetic material. The positions of the shaft within the electromagnetic bearings are monitored by position sensors that provide electrical signals representing shaft locations to a bearing controller, which in turn adjusts the electrical current supplied to the electromagnetic bearings to maintain the shaft at a desired position or within a desired tolerance range. Controlling the shaft entails a 5-axis control. There are typically 2 radial bearings which control 2 radial axes each, and one thrust bearing which controls 1 axis. The desired radial position of the shaft places the shaft axis and the axis of the electromagnetic bearings as substantially coaxial. Substantially coaxial means that the radial position of the shaft can deviate from the axis of the electromagnetic bearings by an allowable tolerance that does not affect the operation of the turbomachinery, but which can vary depending upon the design of the turbomachinery. As used herein, the normal radial operating position of the shaft is also referred to as the centered position, meaning that the shaft axis coincides with (or lies within an acceptable tolerance of) the bearing axis. As turbomachinery normally includes at least two sets of radial bearings and one set of axial bearings, here electromagnetic bearings, the descriptions set forth herein apply to each of the sets of electromagnetic bearings and the 5-axes controlled by these bearings and the associated mechanical back-up bearings. While the bearing controller performs the aforementioned functions to manage the operation of the electromagnetic bearings, the system that controls the turbomachinery or rotating apparatus is normally managed by another controller, referred to as the system controller that manages the operation of the entire system. For example, when the rotating apparatus is a centrifugal chiller, the system controller may monitor all aspects of the cooling system, including operation of a water chiller. The electromagnetic bearing controller and the system controller are in constant communication. For instance, the system controller may send an instruction to the electromagnetic bearing controller to levitate the shaft prior to initiating rotation of the shaft to start the machine. Alternatively, the bearing controller may send the system controller a shut-down instruction when it determines the capacity of the electromagnetic bearings is exceeded.

In the event of a loss of power to the electromagnetic bearing electronics during rotation, a failure of the bearing controller, or during a shutdown of the equipment when the electromagnetic bearings are disabled, the shaft can no longer be supported by the electromagnetic bearings. The components of the compressor, including the electromagnetic bearings, and the shaft are not designed for mechanical contact, particularly when the turbomachinery is operating normally. The shaft must then be supported by mechanical components supplied for this purpose. Therefore, mechanical or safety bearings are provided as a back-up or safety to support the shaft when the machine is not operating or when the magnetic bearings are disabled. Contact with the mechanical safety bearings can also occur for other reasons, typically unusual overload conditions, e.g. external shocks, surge in a turbo machine, etc. When the actual load exceeds the capacity of the bearings over a preset period of time (typically of the order of 1 second), then an instruction for a safety shutdown may be generated by the bearing controller. When the electromagnetic bearings are disabled, the shaft, acting under the force of gravity, comes into contact with the mechanical bearings and eventually comes to rest due to static forces such as friction that may be present. When the shaft axis is oriented horizontally in the turbomachinery, the rest position will normally be the lowest position within the allowable clearance of the radial mechanical bearings due to gravity and will affect radial mechanical safety bearings. The rest position is not predictable in the axial direction. When the axis is oriented vertically, the rest position will normally be the lowest position within the allowably clearance of the axial mechanical bearings due to gravity. The rest position is not predictable in the radial directions for machines having vertically oriented shafts. While the clearance between parts such as shafts and bearings will vary dependent on equipment size, a radial clearance between a shaft and electromagnetic bearing for a typical centrifugal compressor is of the order of about 0.5 mm (0.02 inches), while the radial clearance between the shaft and the mechanical bearings is of the order of 0.2-0.25 mm (0.008-0.010 inches). In addition, flexible damping rings may be inserted between the mechanical bearings and their support, in order to damp shocks when the shaft contacts the mechanical bearing. These damping rings provide an additional radial clearance of the order of 0.07 mm (0.003 inch) when completely compressed. With these tolerances, during normal operation, the electromagnetic bearings maintain the shaft centered and out of contact with the mechanical bearings, thereby avoiding wear of both the shaft and the bearings, while the mechanical bearings remain stationary, even when the mechanical bearings are of the rolling element technology. Thus, there must be some clearance between the shaft and the mechanical back-up bearings when the shaft is magnetically levitated. When the electromagnetic bearings are disabled, the mechanical bearings support the shaft while the turbomachinery is stopped or coasting to a stop, without any contact between the shaft and the electromagnetic bearings. While any one of a variety of mechanical bearings may be used as the back-up or safety bearings, rolling element type bearings are often preferred. The mechanical bearings used in turbomachinery that primarily relies on electromagnetic bearing technology are referred to herein either as (mechanical) safety bearings or back-up bearings. The back-up bearings include both mechanical radial and mechanical axial bearings. Because these safety bearings are internal within the machine and there is no access to the machine without extensive disassembly, excessive wear to these mechanical safety bearings can go undetected, or excessive wear may occur between interval inspections. This undetected excessive wear to the mechanical safety bearings may result in severe damage to the rotating machinery if the machine is kept in operation without adequate maintenance.

In normal operation, the shaft is magnetically levitated prior to onset of rotation at start-up; on shut-down, the shaft remains levitated until the machine is stopped completely. Therefore, during normal operation, the machine should not be rotating when the shaft is in contact with the mechanical bearings. Yet, contact during rotation may occur in some abnormal circumstances. For example, in the event of a power failure, motor operation initially continues as a result of its own inertia, and it can be used as a generator to provide electrical power to the magnetic bearings and their controller while speed is reduced. But, at some point, back-up power due to shaft rotation becomes insufficient and the shaft drops onto the mechanical bearings simply as a result of gravity, and the shaft coasts to a stop during power down. Wear will occur between the shaft and the bearing during this power down. Typically, this contact with the mechanical safety bearings occurs only when the speed is reduced greatly, usually to about 10% of design speed. Nevertheless, wear still occurs between the shaft and the bearing during this power down. This reduces substantially the potential damage to the mechanical safety bearings in case of power failure, but wear still occurs. The shaft may contact the mechanical bearing while rotating in various other cases, for instance, in the event of a failure of the bearing electronics, or when the applied load exceeds the capacity of the bearings. The latter event may occur due to an external shock, surge on a turbo machine etc.

Prior art methods for preventing the risks related to mechanical back-up bearing wear has utilized a counter to determine the number of incidents when bearing electronics is losing control of the shaft, and the result is the triggering of an alarm, or the lock-out of the rotating apparatus when a predetermined number of counts is exceeded. This method does not and cannot distinguish between a hard landing or contact and a soft landing or contact, even though these different types of landings provide different wear results. A determination is then made based on a predetermined count whether the bearings should be inspected or replaced. This method may lead to premature and unnecessary replacement of bearings, which may result in unnecessary down time in operation of the rotating apparatus.

What is needed is a system that automatically and accurately measures mechanical safety bearing wear when desired, for instance, after each event that could potentially generate some wear of the mechanical safety bearings. Such events are typically electrical outages, whether such an outage is intentional or unintentional so that mechanical safety bearing failure can be avoided. Such events may also include a safety shutdown generated by the bearing controller, typically in the case of an overload of the electromagnetic bearing. Depending on the application, the measurement can also be made systematically at each shutdown, whatever the reason for the shutdown.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

The system set forth herein relates to touchdown bearing wear, automatically determining bearing clearance and optionally recording bearing clearance, determining whether there is wear and generating adequate alarms or shut downs to safeguard the machine when wear exceeds predetermined limits. As a minimum, the clearance of the mechanical safety bearings requires at least two known positions of the shaft of the rotating apparatus, at least one of the known positions requiring the shaft to be in contact with the mechanical safety bearings. For example, one of the known positions of the shaft may be the position of the point of contact of the shaft with one of the mechanical safety bearings, as measured by a position indicator associated with the mechanical safety bearing. The other known position may be the centered position of the axis of the shaft within the electromagnetic bearings, which is a number that may be calculated by manipulation of the shaft and recorded, for example when the machine is first operated. The radius of the shaft, at the radial bearing, which is may be determined by reference to the drawing or by direct measurement of the shaft when installed can be subtracted from the difference between the two positions to provide a determination of clearance. By comparing clearance to either a recorded value of initial clearance of the shaft in the bearings, or the nominal clearance of the shaft to the bearings, as provided on the drawings, wear of a mechanical back-up bearing can be determined at any time, and rate of wear can be determined over any time interval. The procedure may be used to measure the clearance and wear for each mechanical back up bearing provided with the rotating apparatus.

The system determines the clearance of the mechanical safety bearings after a shut-down or before a start-up. A stoppage, as used herein, is defined as the stoppage of rotation of the shaft. Rotation of the shaft and levitation of the shaft are independent events, although rotation of the shaft should not occur unless the shaft is levitated. A normal shutdown sequence for the rotating apparatus involves (1) de-energizing the motor; (2) cessation of rotation of the shaft; and (3) de-energizing the electromagnetic bearings, causing the shaft to de-levitate and likely contact the mechanical back-up bearings. Any other shutdown may be an abnormal shutdown. Stoppage, on the other hand, may result in cessation of shaft rotation with or without de-energizing the electromagnetic bearings. Following a stoppage, the electromagnetic bearings normally do not require re-energizing until the next start-up sequence. Following a shutdown, either normal or abnormal, the electromagnetic bearings will require reenergizing during the next start-up sequence. Means for measuring the severity of forces experienced by the mechanical radial bearings as a result of a shutdown or stoppage. These means for measuring forces may be an accelerometer in communication with the controller, or these means may be the electromagnetic bearings themselves, as the amperage to maintain the shaft centered within the electromagnetic bearings, which may be continuously monitored by the controller, provides an accurate determination of the forces experienced at the bearings. After the electromagnetic bearings are de-energized, resulting in a shut-down, the electromagnetic bearings must be energized by the controller to levitate the shaft, and the shaft must be substantially centered within the electromagnetic bearings. The position sensors can be used to determine the position of the levitated shaft to ascertain that it is centered. In order to be levitated, the shaft must comprise a ferromagnetic material or other material, such as cobalt, that is magnetizable when under the influence of an electromagnetic field.

Since the rotating apparatus includes an electrical power source, electromagnetic bearings, a shaft, a controller that controls positioning of the shaft, programming means to permit the controller to control the motion of the shaft, mechanical radial back-up bearings, a set of radial position sensors to locate the radial positions of the shaft within the turbomachine, once the shaft is centered within the electromagnetic bearings. One method for automatically determining the clearance of mechanical safety bearings in the rotating apparatus utilizing electromagnetic bearings, comprises the following steps. The centered position of the shaft within the electromagnetic bearings may optionally be determined by reference to a prior recorded measurement of the centered position of the shaft within the electromagnetic bearings. This recorded measurement may be stored within the memory of the electromagnetic bearing controller, within the memory of the system controller; within the memory of a device in communication with the rotating apparatus or in a written record. After the shaft has substantially ceased rotational motion, the controller directs the application of electrical power to the electromagnetic bearings to move the shaft, if it is not already so located, to its centered position within the electromagnetic bearings, as determined by the position sensors based on the prior recorded measurement of its centered position within the electromagnetic bearings. Next, the controller directs application of electrical power to the one of the electromagnetic radial bearings to move the shaft away from the centered position in a given radial direction. At some point, the radial movement of the shaft is limited, because it has reached the maximum clearance of the mechanical radial bearing as it contacts the mechanical radial bearing. The position of the first point is determined by the position sensors which provide a signal to the controller indicative of this first point. The clearance of the mechanical radial back-up bearing is then determined as a function of the shaft radius, the position of the first point and the distance of the first point from the centered position of the shaft. For example, since the radius of the shaft is known, and the position of the outer diameter of the shaft in the centered position can be measured by the position sensors, the distance that the shaft moves from its centered position until it contacts the mechanical safety bearing minus the radius of the shaft is an indication of the bearing clearance in the considered radial direction. Next, the wear of the mechanical radial back-up bearing can be determined or calculated by comparing the measured clearance of the mechanical radial back-up bearing with a prior recorded value of the clearance of the mechanical radial back-up bearing. This recorded value may be an actual measured value of the back-up bearing clearance as determined when the bearing was new by a similar measurement and recorded, either in memory or by other method. Alternatively the prior recorded value of the clearance of the mechanical back-up bearing may be the nominal bearing diameter, available from typical engineering drawings.

Power is applied by the controller to one of the electromagnetic bearings to move the shaft in a first radial direction into contact with a first side of one of the radial safety bearings. The position sensors determine the position of the shaft at this position and provide a signal to the controller indicative of this position, which is recorded in a memory associated with the controller. As used herein, a memory associated with the controller means a memory that may be part of the controller or a memory that is part of a device that is in communication with the controller, Power is then applied by the controller to the electromagnetic bearings to move the shaft 180° into contact with the oppositely disposed side of the safety bearing. The position sensors again determine the position of the shaft at this second position and the position sensors provide a second signal to the controller indicative of this second position, which is recorded in memory. The difference between the two position values can be determined by a software programs associated with the memory having the necessary algorithms to evaluate the recorded values to determine the diametral clearance of the bearing. By comparing these measured values to the initial diametral clearance of the bearing, determined when the radial bearing was new (whether actual measured values or nominal values), recorded and stored in memory, provides an indication of a first value of bearing clearance along the diameter corresponding to the aforementioned two positions as well as wear, which values may be recorded in the memory associated with the controller. A first measurement of the overall clearance of the radial bearing along the axis of the first two measured positions can be determined by this shaft movement. The measurement also provides a first measurement as to where the geometric center between the mechanical safety bearings lies. The programming instructions that program the electromagnetic bearing controller to move the shaft to a given sequence of positions by application of power can be programmed into the electromagnetic bearing controller, or such instructions can be sent to the electromagnetic bearing controller from other devices in communication with the electromagnetic bearing controller. These could include, for example, the controller managing operation of the system, such as a cooling system when the rotating apparatus is a centrifugal compressor, or a remotely connected computer or dedicated firmware.

The electromagnetic bearing controller may now be instructed to apply power to the electromagnetic bearings to move the shaft to its center position (within allowable tolerances), as determined by the position sensors. The controller may now apply power to the electromagnetic bearings to move the shaft 90° into contact with the safety bearings along a radius substantially perpendicular to the diameter between the first shaft/bearing contact position and the second shaft/bearing contact position described above. The new position, substantially perpendicular to this diameter, provides a third shaft/bearing contact position. The position sensors determine the position of the shaft at this contact position and provide a signal to the controller indicative of this position, which is then recorded in the memory associated with the controller. The controller next applies power to the electromagnetic bearings to move the shaft 180° into contact with the oppositely disposed side of the mechanical safety bearings from the third shaft/bearing contact position to a fourth shaft/bearing contact position. The position sensors determine the position of the shaft at this position and provide a signal to the controller indicative of the position, which is recorded in the memory associated with the controller. The software then calculates the difference between the recorded position values at the third shaft/bearing contact position and fourth shaft/bearing contact position to provide a second value of diametral distance across the bearing. The second value is also recorded. Comparison between the second measured (and recorded) diametral distance and the initial diametral distance across the bearing, determined when the mechanical radial bearing was new, recorded and stored in the memory associated with the controller, provides an indication of a second value of bearing clearance, which value is recorded. The second measurement of the overall wear of the radial bearing can be determined by this shaft motion amplitude. The measurement also provides a second measurement as to where the geometric center between the mechanical safety bearings lies. If either of the measured values of mechanical bearing wear exceeds a predetermined value for bearing wear, this is an indication that a dangerous condition may exist. The procedure may be applied to each set of radial bearings to determine wear. For the axial direction, power is applied by the controller to the electromagnetic bearings to bring the shaft into contact with the mechanical axial safety bearings by movement in both axial directions. Position indicators communicate signals to the controller indicative of the position of the shaft, which is saved in the memory associated with the electromagnetic bearing controller. The difference in movement, which may be calculated by the software, provides an indication of the clearance of the mechanical thrust bearing. The difference in motion amplitude, when compared to motion amplitude when the mechanical axial bearing was new, provides an indication of the wear of the axial bearing.

When an excessive bearing wear condition is suspected, the turbomachinery can be shut down for further evaluation. If desired, when the touchdown bearing clearance test indicates excessive wear of the mechanical safety bearings, the system controller can lock down further operation of the turbomachinery. However, different thresholds can be set. A low predetermined wear value may trigger an alarm for an early warning that an inspection should be planned, while higher predetermined wear value may result in the system controller automatically locking out further operation of the machine, if predetermined wear values are exceeded. When the predetermined wear results in a warning, the warning may result in a warning message generated on a PLC indicating a clearance concern and requiring a positive action to clear. The warning may also be a specific visual alarm light generated on the control panel, also requiring a positive action to clear. Alternatively, the turbomachinery can be shutdown until further inspection determines that an excessive wear condition does not exist. This inspection may entail disassembly so that a visual inspection and further dimensional inspection can be performed. Still another option may include systematic replacement of the mechanical safety bearing once the machine is disassembled, without any further inspection of bearings.

Set forth in this method of measuring wear of safety bearings is the ability of the electromagnetic bearing controller to provide power to the electromagnetic bearings to move the shaft and position the shaft in the axial direction and in any radial direction in a systematic fashion as an integral shut-down or start-up procedure. The method comprises the steps of applying power to the electromagnetic bearings by the electromagnetic bearing controller. The electromagnetic bearing controller has internal control algorithms to modulate the currents to the coils in order keep the position of the shaft at or very close to a reference position along each of the five control axes. In the normal mode of operation, the reference position is substantially centered along each of the five axes. In the process per the invention, the control algorithms of the magnetic bearing controller continue to operate normally, but the reference positions are altered. Different successive reference positions are given to the bearing controller according to a programmed sequence stored in the electromagnetic bearing controller, in the system controller as part of the control panel of the machine or in another remote device that is in communication with the electromagnetic bearing controller. The program sequence results in power applied to the electromagnetic bearings to move the shaft into contact with the mechanical safety bearings, which moves the shaft in predetermined patterns in substantially radial directions, so that the shaft contacts the radial mechanical safety bearings, and the points of intersection of the shaft with the radial mechanical safety bearings are recorded to assist in determining the condition of the radial mechanical safety bearings. The programmed sequence also results in power applied to the electromagnetic bearings to move the shaft in an axial direction into contact with the axial safety bearings to assist in determining the condition of the radial mechanical safety bearings. Each subsequent movement of the shaft into contact with the mechanical safety bearings is accomplished in a similar manner. Position indicating apparatus or position indicating sensors are used to determine the coaxiality of the shaft axis and the bearings axis, which information can be used to provide an indication of bearing wear. Logic, alternatively described as programming, directs changes to the reference positions of the shaft in a predetermined sequence, resulting in movement of the shaft with respect to the mechanical safety bearings. The logic controls movement of the shaft along a predetermined path that results in contact of the shaft with the mechanical safety bearings. The position sensors signal these positions of contact which are communicated to the controller or other equipment that can communicate with the controller. These signals are indicative of a position and are stored in memory.

The electromagnetic bearing controller directs power to be applied to the windings of the electromagnetic bearings to move the shaft center along a first preselected axis. Usually this axis is through the center of the shaft when it is at rest, to the normal, centered position and the first preselected axis is between the first and second shaft/bearing contact positions, the second position being determined after the first position is determined. For a machine with a vertically-oriented shaft, it may be necessary to first move the shaft with the electromagnetic bearings into contact with a mechanical safety bearing and then proceed with the measurements in the same manner as a machine with a horizontally-oriented shaft. The second axis is then determined based on the first axis and the first and second shaft/bearing contact positions. Furthermore, the preselected axes are not limited to simply a first and a second preselected axis perpendicular to one another. The second axis may be selected based on any desired angle, the second axis being perpendicular to the first axis being only exemplary. The sequence of reference positions and motions is described using a cylindrical coordinate system, that is, in radial directions from a central axis. This simplifies both programming and understanding. But a variety of different patterns of motion could lead to similar results. For instance, the programming could provide the shaft with a circular motion around the central axis, with a radius greater than the normal clearance of the mechanical back-up bearings. Being limited by the clearance of the back-up bearings, the motion of the shaft center would actually result in a circular with a smaller radius than programmed, this radius being equal to the clearance of the mechanical back-up bearings. In addition, in the above discussions, for the sake of simplicity, the mechanical back-up bearings and their support are assumed to be perfectly rigid. However, as one skilled in the art will recognize, these components have some flexibility. The bearing supports are designed with flexibility. Also, the mounting for the back-up bearings may be flexible, since it may be necessary to damp shocks in the event that the shaft contacts the back-up bearings. This may be accomplished by inserting elastic rings between the back-up bearings and their support. In this circumstance, when the shaft comes into contact with the bearings, applying a force to it, there is an opposing force resisting the applied force. But the electromagnetic bearing will still attempt to reach the reference position, until either the elastic mount is completely squeezed, or the maximum capacity of the bearing is reached, whichever comes first. This small change due to inherent flexibility is easily included in the programming and in any algorithms used for calculations of wear. In any case, as long as the shaft can move freely within the clearance, the electromagnetic bearings have to support only the weight of the shaft; the current delivered by the bearing electronics to each coil being independent of the position of the shaft. When the shaft initially contacts the mechanical back-up bearing, the current begins to change. As the current supplied to the coils provides an indication of bearing load, changes in the current supplied to the coils also serves as an indicator of contact between the shaft and the back-up bearings. When the bearing electronics continues to attempt to move the shaft to a position that cannot be reached because of contact between the mechanical back-up bearings and the shaft, then the current increases, while the position sensors do not indicate any change of position of the shaft. Therefore, both the position of the shaft and the current sent to the coils of the electromagnetic bearings should be monitored. When the current sent to the coils increases with little or no change of the shaft position, then the shaft is in contact with the mechanical bearings. The operation should be programmed to stop when the current begins to increase, and should be halted before the current reach the shut-down safety level.

Advantages of the apparatus and method include mechanical bearing replacement based on actual wear rather than on a less reliable predetermined count. Because the bearing life will be based on actual bearing wear, it is anticipated that there will be longer bearing life between replacements, and bearing replacement will be based on more accurate wear data. Because the bearing life is extended, the mean life between bearing replacement will result in less down-time for the machine, resulting in higher realization.

Certain advantages of the embodiments described herein are that the process can be incorporated into existing turbomachinery without adding additional equipment. The process will detect the wear of the touchdown bearings and will allow for more informed decisions regarding maintenance, inspection and replacement of mechanical bearings, minimizing shutdowns of such machinery and reducing the prospects for damage.

Alternative exemplary embodiments relate to other features and combinations of features as may be generally recited in the claims.

### BRIEF DESCRIPTION OF THE FIGURES

FIG. 1 depicts a building having a heating and cooling system that includes turbomachinery, a centrifugal compressor, located in the basement and a rooftop cooling tower.

FIG. 2 is a schematic cross-sectional view of a centrifugal compressor of FIG. 1 that utilizes electromagnetic bearings.

FIG. 3 is a detailed partial view of a centrifugal compressor of the present invention.

FIG. 4A and 4B are cross-sectional views of the shaft and the mechanical radial bearings in contact at two diametrally-opposed positions.

FIGS. 5A and 5B are cross-sectional views of the shaft and the mechanical radial bearings in contact at two diametrally-opposed positions and substantially transverse to the positions shown in FIG. 4.

FIG. 6 is a partial cross-sectional view of the turbomachinery depicting relative positions of the shaft, the rotor, the electromagnetic bearings, the mechanical radial bearings and the position sensors.

FIG. 7 is a partial cross-sectional view of the turbomachinery depicting relative positions of the shaft, the rotor, the electromagnetic bearings, the mechanical axial bearings, and the position sensors.

FIG. 8 is a partial cross-sectional view of the shaft and the mechanical axial bearings which the shaft at two extreme axial positions.

FIG. 9 depicts the position of the radial position sensors with respect to a radial bearing.

FIG. 10 depicts the position of the axial position sensors with respect to the second radial bearing.

### DETAILED DESCRIPTION OF THE EXEMPLARY EMBODIMENTS

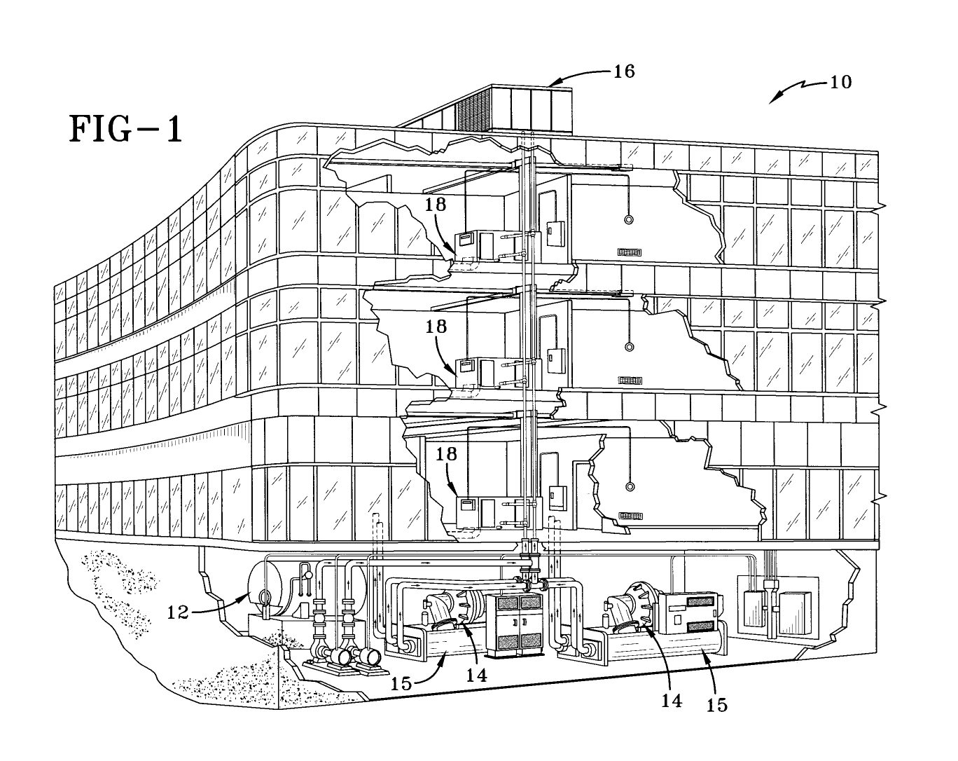

FIG. 1 depicts a building 10 equipped with a typical heating and cooling system. The heating and cooling system includes a boiler 12 and a centrifugal compressor 14 in the basement along with an evaporator and a condenser 15. Centrifugal compressor 14 is equipped with electromagnetic bearings. The condenser 15 is in fluid communication with a cooling tower 16, shown as located on the rooftop, but whose location is not so limited. Each floor of building 10 is equipped with an air handling system 18 to distribute air to each floor of the building.

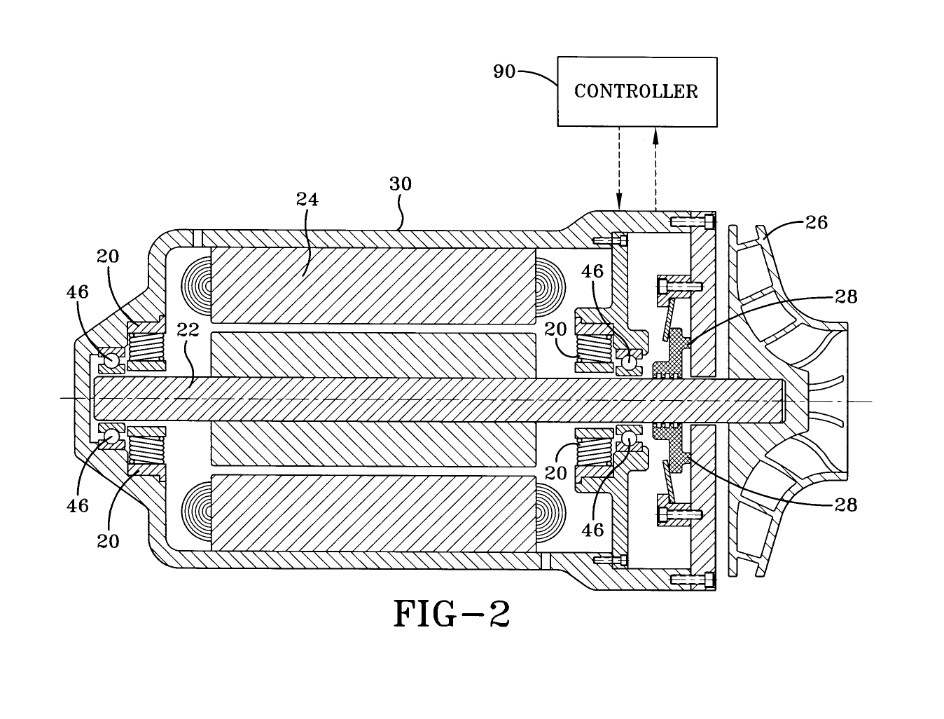

FIG. 2 is a cross sectional view of centrifugal compressor 14 of FIG. 1. Centrifugal compressor 14 is similar to other prior art centrifugal compressors, except that it is equipped with a high speed motor 24 driving impeller 26, and electromagnetic bearings 20 surrounding either end of a shaft 22. A power supply provides power to drive the compressor and to power the electromagnetic bearings. Power amplifiers are provided to amplify and condition power from the power source and to provide power to the magnetic coils of the electromagnet. Electromagnetic bearings are in communication with an electromagnetic bearing controller, shown remotely located in FIG. 2 and in communication with the interior of the compressor, and which may be located at a control panel for the turbomachinery, but its location is not so restricted. Included with the electromagnetic bearing controller are power amplifiers provided to amplify and condition power from the power source and to provide power to the magnetic coils of the electromagnets. The electromagnetic bearing controller can communicate with the electromagnetic bearings and sensors such as position sensors in any convenient way. Communications between the controller and the position sensors may be accomplished by hardwiring to the electromagnetic bearings and sensors or by radio frequency (RF) communications that includes transmitters and receivers. The method of communications between the electromagnetic bearings and the system controller (or other device) is not an important aspect of this invention. The electromagnetic bearing controller also modulates current from the power amplifiers to maintain the shaft centered within the electromagnetic bearings. Since it is not physically possible to maintain a shaft perfectly centered, the electromagnetic bearing controller modulates the current to maintain the rotating shaft within a location envelope, or tolerance envelope within the electromagnetic bearings 20 by constantly monitoring signals provided by position sensors 132 indicating the position of the rotating shaft 22. When powered, electromagnetic bearings 20 suspend shaft 22 within bearings 20, so that shaft 22 can rotate with minimal frictional losses. The shaft can be related to various utilities depending on the nature of the machine. For instance, it can include a motor 24 to drive an impeller 26. If the machine is a compressor, a gas seal 28 normally is provided between shaft 22 and housing 30 to prevent leakage of fluid across the gap between shaft 22 and the housing 30. In the embodiment as shown, safety mechanical back-up bearings 46 are roller element bearings and are located at either end of shaft 22.

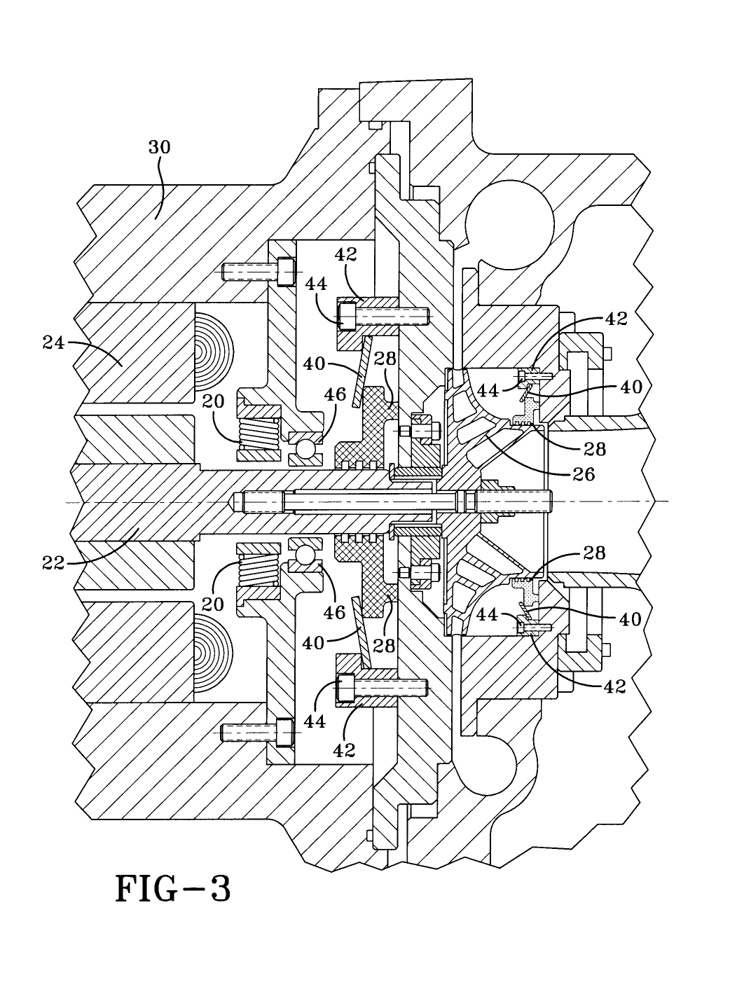

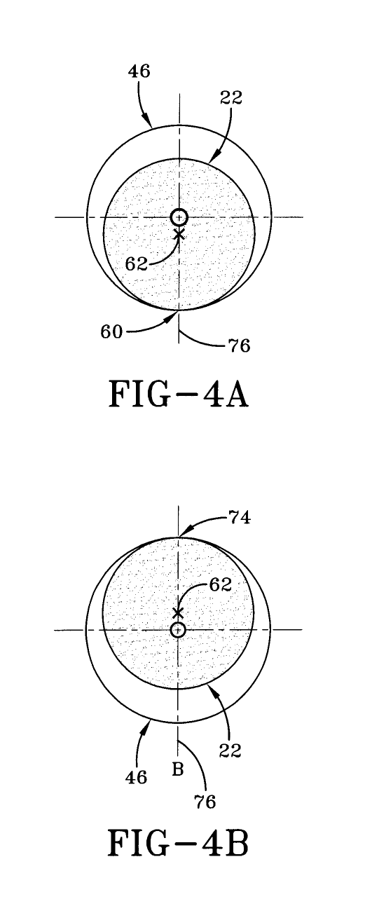

FIG. 3 is a detailed view of centrifugal compressor 14 at one end of housing 30 Safety bearings 46 at one end of the shaft are visible in FIG. 3. In one embodiment, the radial clearances between labyrinth seal 28 and impeller 26 of the turbomachine on one hand and labyrinth seal 28 and shaft 22 on the other hand are at least equal to or greater than the clearance between shaft 22 and mechanical safety bearings 46. This dimensional relationship prevents damage or unnecessary wear between the labyrinth seals and their mating parts, allowing the mechanical safety bearings 46 to act as the wear surface in this embodiment. A rotating shaft 22 of a turbomachine having electromagnetic bearings 20, such as a compressor and more specifically a centrifugal compressor 14 used in an air conditioning or refrigeration application, and the relationship between compressor shaft 22 and mechanical safety bearings 46 is described in FIG. 4 when power is removed, such as occurs during a normal shutdown or a power failure, from centrifugal compressor 14. FIG. 4A depicts the position of the shaft and the mechanical safety bearings when power is removed from electromagnetic bearings 20. The mechanical safety back-up bearings 46, usually rolling element bearings, that extend around shaft 22 for 360° in a conventional manner to receive shaft 22 on loss of power to permit shaft 22, which still may be rotating after power removal from the electromagnetic bearings 20, to coast safely to a stop. As the shaft coasts to a stop, wear may occur between shaft 22 and mechanical safety bearings 46. Each time power is removed from the electromagnetic bearings while the shaft is still rotating, contact occurs between mechanical safety bearings 46 and shaft 22, which can result in wear. Wear also may occur for other reasons during operation of the machine. For example, wear may occur as a result of external shocks, such as for example an earthquake, surge, or other unusual overload events. The machine may continue to operate temporarily during such events, even though such events result in an out of the ordinary range of conditions, which the machine is expected to withstand. However, such conditions may result in the initiation of an automatic shutdown when such conditions are detected, when such event results in an actual load that exceeds the capacity of the electromagnetic bearings for a preselected amount of time. Wear on the mechanical safety bearings is cumulative over time. However, as the mechanical safety bearings are in a sealed compressor, they are not readily accessible for inspection, whether visual or dimensional; therefore this cumulative wear can evolve into excessive wear over time, even between regularly scheduled maintenance.

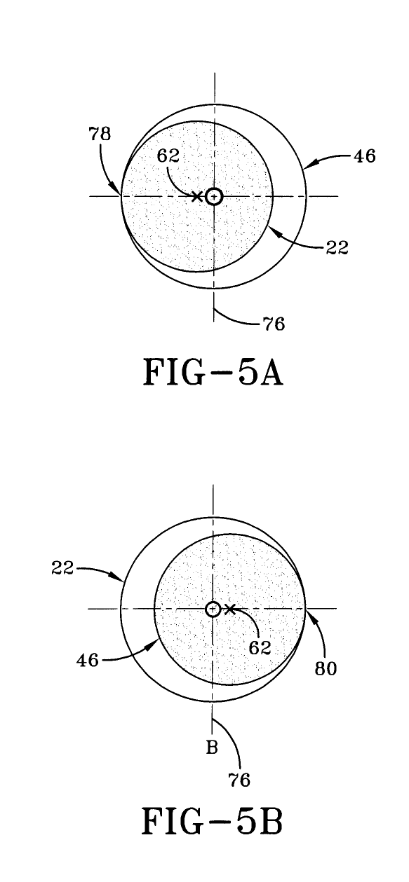

A procedure can be implemented to automatically determine the wear sustained by mechanical safety bearings 46 at any time when the machine is stopped, that is to say, when shaft 22 is not rotating. This simple procedure determines whether it is necessary to further evaluate or inspect mechanical bearings 46 for damage, or to replace bearings 46. If the turbomachinery is operated with worn bearings, further damage to the turbomachinery may result, and in certain circumstances the damage could result in a catastrophic failure. This damage usually results in damage sufficient to require an extensive shutdown while repairs are accomplished, placing the turbomachinery out of service. A procedure to determine the wear sustained by the mechanical safety bearings is described by reference to FIGS. 4 A and B and FIGS. 5 A and B prior to returning the turbomachinery to operation after a shutdown.

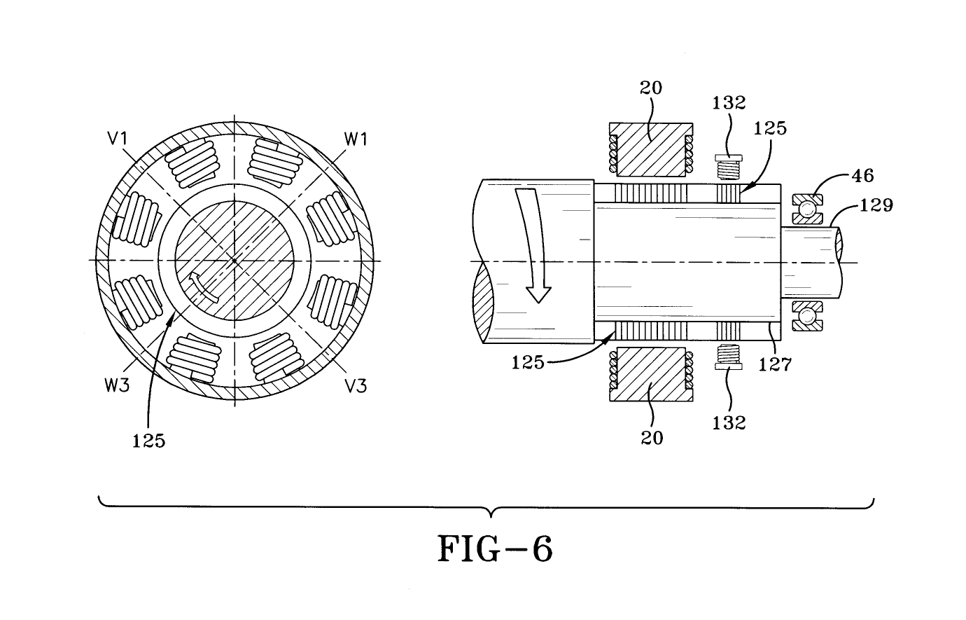

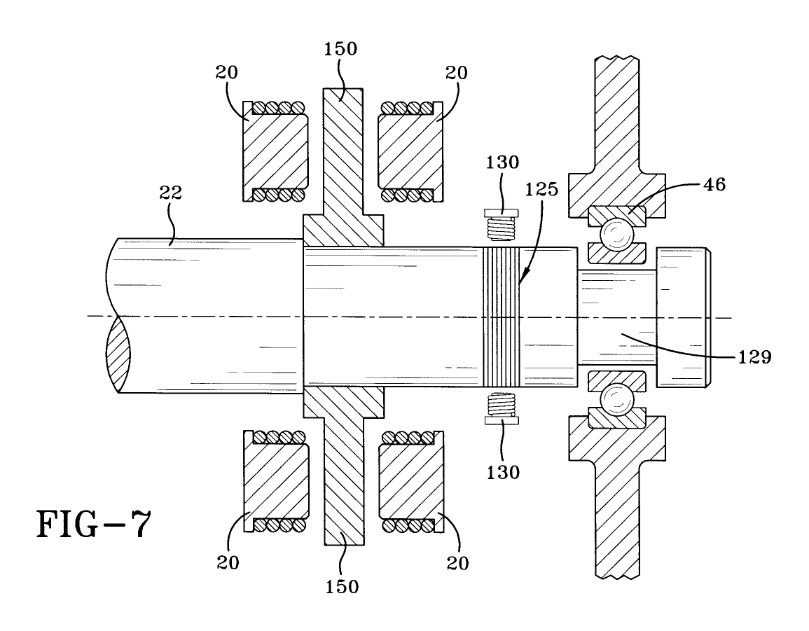

FIGS. 6 and 7 depict a partial cross-section of one end of a typical shaft of a turbomachine, such as a centrifugal compressor. Shaft 22 is depicted extending between electromagnetic bearings 20. Laminations are also depicted in FIG. 6. Shaft 22 has a first shaft diameter 127 at a first axial position, and a second shaft diameter 129 at a second axial position for the shaft depicted in FIGS. 6 and 7. It will be recognized by those skilled in the art that shaft 22 may have a uniform diameter along its axis, or a series of diameters. The first shaft diameter 127 extends beyond electromagnetic bearings 20 and is larger than second diameter 129 in this example. Laminations 125 extend from shaft 22, mating it to the electromagnetic bearings 20. Also positioned adjacent to shaft 22 are axial position sensors 130. In the radial direction, radial position sensors 132 may be included in a common arrangement with each mechanical radial magnetic bearing. Safety bearings 46 are also positioned adjacent to shaft 22. Prior to activation of the rotor causing shaft 22 to rotate, electromagnetic bearings 20 are energized to levitate shaft 22 and center shaft 22 in electromagnetic bearings 20. Centering of shaft 22 in electromagnetic bearings 20 also substantially centers shaft 22 in safety bearings 46. Radial position sensors 132 measure the position of shaft 22 and provide a signal indicative of this position to the controller. When the controller determines that shaft 22 is centered within electromagnetic bearings 20, operation of the rotating apparatus can be initiated, as the axial position sensor 130 measures the axial position of the shaft, etc. As depicted in FIG. 6, mechanical safety bearings 46 are positioned adjacent to second shaft diameter 129. However, the position of mechanical safety bearings is not restricted to the configuration shown in FIG. 6, which depicts mechanical radial safety bearings, and they may be positioned anywhere along the axis of shaft 122. FIG. 7 also depicts axial electromagnetic bearings and mechanical axial safety bearings 150 and axial position sensors 130 between electromagnetic bearings 20 and radial mechanical safety bearings 46.

In wear situations, such as when power is lost to electromagnetic bearings 20 or possibly under severe surge conditions for a compressor turbomachine, shaft 22 will no longer remain centered in electromagnetic bearings 20. However, mechanical safety bearings 46 are positioned to contact shaft 22 under such conditions to prevent contact between shaft 22, electromagnetic bearings 20 and other critical components of the turbomachinery. When the turbomachinery is positioned horizontally as shown in FIGS. 6-8, gravity will force the shaft 22 downward into contact with radial mechanical safety bearing 46. When the turbomachinery is positioned vertically, shaft 22 will contact radial mechanical safety bearing 46 randomly along the inner race of mechanical safety bearings 46. However, mechanical safety bearings prevent inadvertent damage to the electromagnetic bearings or other critical machine components. Under such conditions, shaft 22 will contact mechanical safety bearings 46. But failure of the mechanical safety bearings 46 can result in, as a minimum, damage to the shaft 22 or other system components, damage to the electromagnetic bearings 20 or, in the worst case scenario, a catastrophic failure of the turbomachinery.

Wear experienced by the mechanical radial safety bearings 46 can be readily monitored to prevent failure, to determine scheduled or unscheduled maintenance and to conduct inspections. This procedure can be performed in a sequence each time the turbomachinery is started or when it is shut down. FIG. 4 depicts shaft 22 in contact with mechanical safety bearing 46 along the axis at point 60, for a rotating apparatus or turbo machine having a horizontally oriented shaft. For a rotating apparatus or turbo machine having a vertically oriented shaft, shaft 22 can be brought into contact with mechanical safety bearings 46 at point 60 when the controller activates electromagnetic bearings 20 and moves shaft 22 until it contacts mechanical safety bearings 46 at point 60. This can be accomplished by providing a high current to one of the electromagnetic coils to attract the shaft to the corresponding pole. Alternatively, the electromagnetic bearing controller can manipulate the shaft by providing power to the bearings in accordance with a sequence of reference positions until the sequence results in the shaft contacting the mechanical back-up bearings. The contact is determined by comparison of the actual measured position, as determined by the position sensors, and the reference position, and the deviation is determined by the electromagnetic bearing electronics. The sequence of reference positions can be generated by a software routine included in the control software of the system controller, in the electromagnetic bearing controller or in some remote machine in communication with the electromagnetic bearing controller. Regardless of the orientation of the shaft, radial position sensors 132 can determine the radial position of shaft 22 and communicate a signal indicative of the position to the electromagnetic bearing controller. The controller can then power electromagnetic bearings 20 to move shaft 22 to a diametrally opposed position 180° from point 60 until it contacts radial mechanical safety bearings 46 at point 74 as depicted in FIG. 4B using either of the methods described above. Alternatively stated, the controller instructs the electromagnetic bearings 20 to move shaft 22 from a first contact position at point 60, contacting radial mechanical safety bearings 46, across the diameter of bearings 46 to a second, opposite contact position at point 74 where shaft again contacts radial contact safety bearings. Radial position sensors 132 determine the position of shaft 122 at point 74 and provide a signal indicative of the shaft position to the electromagnetic bearing controller, where they are recorded and stored in memory. Alternatively, the related information can be stored and processed in another memory, such as the system controller as previously discussed. The relevant controller may determine the difference in value between the two measured positions, which is recorded and stored. The newly determined value is compared to the previously recorded value and the value recorded when the mechanical safety bearings 46 were new. The comparison between the most recently measured values with the measured value stored in memory when the mechanical safety bearings 46 were new immediately provides an indication of the overall clearance or wear of the mechanical safety bearings 46 across the diameter (line) which is defined by points 60 and 74. A determination can be made as to whether the bearings 46 require replacement or servicing. This can be done by determining if wear has reached or exceeds a predetermined value. If desired, the value recorded at the most recent startup can be compared to the value from a previous startup or preselected series of prior starts to determine wear over any preselected interval of time to track incremental wear as well as rate of wear over this preselected time interval. This can be included as an algorithm in the software programmed into the electromagnetic bearing controller 20, the system controller or in a device or machine in communication with the bearing controller 20. This wear rate can be compared to wear rates based on prior measurements of wear over prior recorded time intervals. If the measurements indicate that a wear rate is increasing or accelerating, as determined from comparison of prior recorded wear values over preselected intervals of time, even when wear is within an acceptable predetermined level, or wear in excess of a predetermined wear rate, a warning signal may be generated, either on the PLC or by activating an alarm light on the control panel. Such a warning light, as previously disclosed, may require a positive action to clear or remove.

While the Figures, for illustration purposes show initial point 60 as the low point for a turbomachine with a shaft that is horizontally oriented, the diameter defined by points 60 and 74 do not have to include this low point 60. The diameter defined by any two points in any arbitrary direction may be selected. Usually, the poles of the radial bearings are disposed at an angle from either a horizontal diameter or a vertical diameter across the bearings, and usually this angle is 45° from both the horizontal and vertical directions. It may be easier, and preferable, to select points located at these poles so that the diameters are oriented at a predetermined angle, such as 45° from a diameter perpendicular to, for example a, horizontally oriented axis. Thus, diameters located along lines W1-W3 and V1-V3 as shown in FIG. 6 may be preferable. It should be noted, however, that since the controller is programmable, it may also be programmed to select not only the same points and the same diameters for each test, but also points, and hence diameters, on a random basis by including a random selection feature in the programming.

Optionally, wear measurements can be repeated as part of a startup procedure, or preferably after a shut-down. Referring again to FIGS. 5A and 5B the controller provides power to electromagnetic bearings 20 to move shaft 22 to a position 90° from either point 60 or point 74 of FIG. 4A or FIG. 4B respectively. Movement of 90° along the inner circumference of the mechanical bearing from either point 60 or point 74 of FIG. 4 is used as an example, as any other angular interval may be selected. In FIG. 5A, shaft 22 is brought into contact with mechanical radial safety bearing 46 at point 78. Radial position sensors 132 measure the position of shaft 22 and provide a signal indicative of the position to the controller, where they position is recorded. The controller then provides power to electromagnetic bearings 20 move shaft 22 about 180° until shaft 22 contacts mechanical radial safety bearings 46 at point 80, as depicted in FIG. 5B. Radial position sensors 132 determine the position of shaft 122 at point 80 and provides a signal to the controller, as previously discussed where the new position is also recorded. Clearance is calculated as described above. Additional measurements may be taken in similar fashion. Clearance may then be determined by the controller as an absolute value calculation based on worst-case measurements, or may be based on an average value calculation of the measurements or on any other statistical function desired. The determined or measured clearance is then compared with a predetermined value used to evaluate acceptability of the mechanical safety bearings for continued use. For example, a determination that the mechanical safety bearings have experienced a predetermined wear of about 20% may trigger a warning that indicates servicing or further inspection is necessary. A determination that the mechanical safety bearings 46 have experienced a predetermined wear of about 50% may trigger an automatic lockout of the turbomachinery by the controller, indicating that further operation is unsafe and that replacement of the mechanical safety bearings 46 is required before further operation will be permitted.

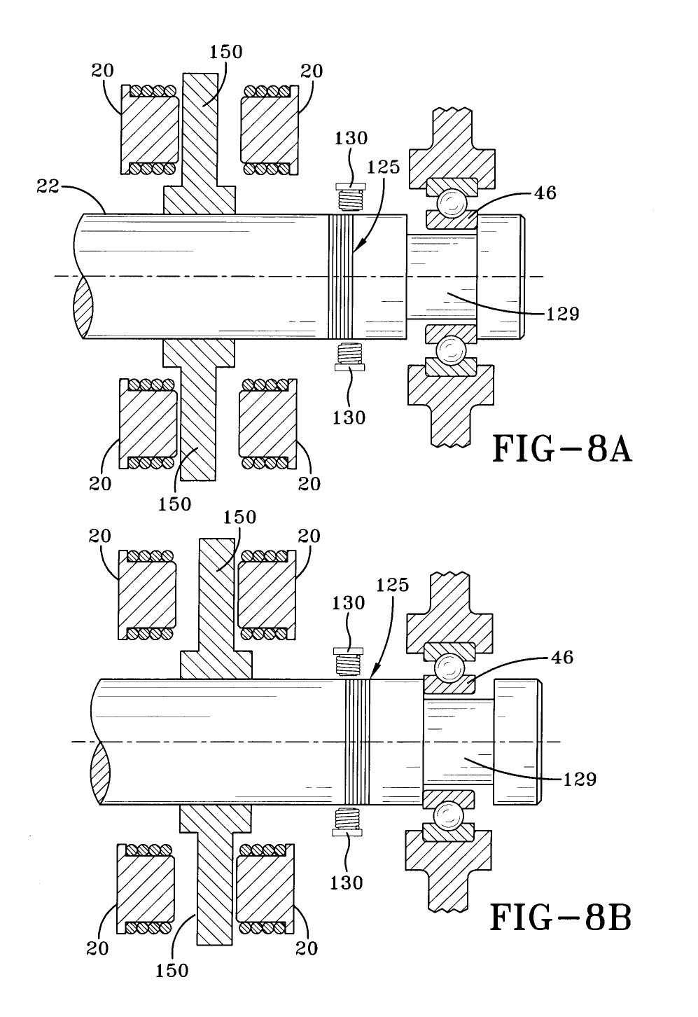

Clearance measurements for mechanical axial safety bearings can be made in a similar manner. Axial bearings are used to counteract movement of shaft 22 in the axial directions. When power to the electromagnetic bearings is removed, shaft 22 is prevented from moving excessively in the axial direction by the mechanical axial safety bearings. The mechanical axial safety bearings may bear the load due to axial displacements of shaft 22 once power is removed. As with the mechanical radial safety bearings, wear experienced by the mechanical axial safety bearings can be readily monitored to prevent failure, to determine scheduled or unscheduled maintenance and to conduct inspections. Preferably, clearance measurements for the mechanical axial safety bearings are performed after shut-down, that is, after shaft 22 has stopped rotating. FIG. 8 illustrates the method for accomplishing clearance measurements for mechanical axial safety bearings 150. The controller energizes radial electromagnetic bearings 20 to move shaft 22 in a first axial direction as shown in Figure A, an inner race of the axial safety bearing sliding along shaft 22 until its motion is obstructed. Axial position sensors 130 measure the first position of shaft 22 with respect to the safety mechanical bearing and provide a signal indicative of the position to the controller, where the results are recorded. The controller then provides power to electromagnetic bearings 20 to move shaft 22 in a second axial direction as shown in Figure B, the inner race of the safety bearing again sliding along shaft 22 until its motion is again obstructed. Axial position sensors 130 again measure the position of the shaft 22 with respect to the axial safety bearings and provide a signal to the controller, where the results are recorded. The difference between the measured, recorded positions, again calculated by the controller, is recorded and gives the clearance of the axial bearing. This recorded value may be compared against measurements made when the bearings were new. The difference in the position measurements taken at the most recent start-up and measurements made when the bearings were new provides data regarding overall bearing wear. Incremental wear can be determined by comparing the most recent measurements with one or more prior recorded measurements. As with the mechanical radial safety bearings, the measured wear for the mechanical axial safety bearings is then compared with a predetermined value that is used to evaluate acceptability of the bearings for continued use.

The predetermined values used to evaluate the mechanical safety bearings 46 will vary from system to system and will depend upon a number of variables. For example, material used in the safety bearings 46, the size of the safety bearings, the size of shaft, the speed of the shaft, the materials used in the shaft, etc. are all variables that will affect the selection of the predetermined values used to evaluate the mechanical safety bearings 46 for continued use. The automatic testing sequence to measure wear of mechanical safety bearings may be conducted separately after a shut-down or before a startup of the turbomachinery for radial mechanical safety bearings, such as depicted in FIG. 6, and on the axial mechanical safety bearings, such as depicted in FIGS. 7 for turbomachinery so equipped.

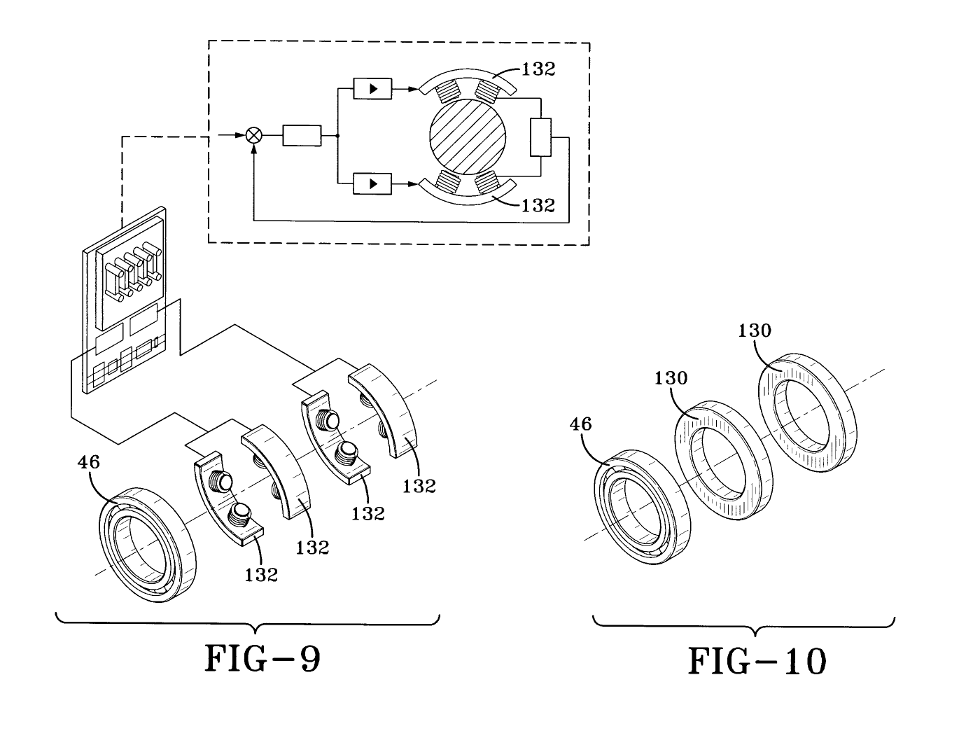

FIGS. 9 and 10 are provided simply to show the relative positions of the axial position sensors 130 and radial position sensors 132 with respect to the shaft and with respect to the radial bearings.

It should be understood that the application is not limited to the details or methodology set forth in the following description or illustrated in the figures. It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products that accomplish the required movements of the shaft on any machine-readable media for accomplishing its operations. The embodiments of the present application may be implemented using an existing computer processors or controllers, or by a special purpose computer processor for an appropriate system, incorporated for this or another purpose or by a hardwired system.

While the exemplary embodiments illustrated in the figures and described are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the systems as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

What is claimed is:

1. A method for automatically determining the clearance of mechanical safety bearings in a rotating apparatus utilizing electromagnetic bearings, comprising the steps of:
(a) providing a rotating apparatus that includes an electrical power source, electromagnetic bearings, a shaft, a controller that controls positioning of the shaft, programming means to permit the controller to control the motion of the shaft, at least two mechanical radial back-up bearings, a radial position sensor in proximity to each radial back-up bearing to locate the position of the shaft within the turbomachine;
(b) determining a centered position of the shaft within the electromagnetic bearings;
(c)after the shaft has substantially ceased rotational motion, directing application of electrical power from the controller to the electromagnetic bearings to move the shaft to a first position at which the shaft contacts a first mechanical radial back-up bearing at a first point;
(d) determining the position of the first point;
(e) providing a signal to the controller indicative of the position of the first point;
(f) determining the clearance of the mechanical radial back-up bearing as a function of the shaft radius, the position of the first point and the distance of the first point from the centered position of the shaft within the first mechanical radial back-up bearing;
(g) repeating steps (b) through (f) for additional radial back-up bearings; and
(h) determining the wear of each mechanical radial back-up bearing by comparing the measured clearance of the mechanical radial back-up bearing with prior determinations of clearance of each mechanical radial back-up bearing.

2. The method of claim 1 wherein the electromagnetic bearings include a plurality of coils radially positioned and spaced around the shaft, and movement of the shaft is accomplished by directing application of sufficient power to one coil of the plurality of coils to draw the shaft toward the pole.

3. The method of claim 1 wherein the clearance measurements, the wear measurements and the time of the measurements are recorded.

4. The method of claim 1 further including an additional step, prior to step (b), of determining whether the performance of additional steps are warranted based on a controller evaluation of prior wear history or based on forces measured and transmitted to the controller during a shut-down or a stoppage exceed a predetermined threshold force.

5. The method of claim 3 further including an additional steps of evaluating the clearance measurements and wear measurements, determining whether the clearance or wear measurements exceed a predetermined limit and providing a visual warning when the wear measurement are within 50% of the predetermined limit and preventing further normal operation when the predetermined limit is exceeded.

6. A method of automatically determining the clearance of mechanical safety bearings in a rotating apparatus utilizing electromagnetic bearings, comprising the steps of:
(a) providing a rotating apparatus that includes an electrical power source, electromagnetic bearings, a shaft, a controller that controls operation of the shaft, programming means to permit the controller to control the motion of the shaft, at least two mechanical radial back-up bearing, a radial position sensor to locate the position of the shaft within the turbomachine;
(b) while maintaining the shaft at a centered position within a first radial bearing by directing application of electrical power from the controller to the electromagnetic bearings, after the shaft has substantially ceased rotational motion, directing application of electrical power from the controller to the electromagnetic bearings to move the shaft to a first position at which the shaft contacts a second mechanical radial back-up bearing at a first point;
(c) determining the position of the first point;
(d) providing a signal to the controller indicative of the position of the first point;
(e) recording the position of the first point in a memory storage device associated with the controller;
(f) then, directing application of electrical power from the controller to the electromagnetic bearings to move the shaft to a second position 180° from the first position at which the shaft contacts the second mechanical radial back-up bearing at a second point diametrally opposite the first point;
(g) determining the position of the second point;
(h) providing a signal to the controller indicative of the position of the second point;
(i) recording the position of the second point in the memory storage device associated with the controller;
(j) then, directing application of electrical power from the controller to the electromagnetic bearings to move the shaft to a third position at a predetermined angular distance from the second position at which the shaft contacts the second mechanical radial back-up bearing at a third point;
(k) determining the position of the third point;
(l) providing a signal to the controller indicative of the position of the third point;
(m)recording the position of the third point in a memory storage device associated with the controller;
(n) then, directing application of electrical power from the controller to the electromagnetic bearings to move the shaft to a fourth position 180° from the third position at which the shaft contacts the second mechanical radial back-up bearing at a fourth point diametrally opposite the third point;
(o) determining the position of the fourth point;
(p) providing a signal to the controller indicative of the position of the fourth point;
(q) recording the position of the fourth point in the memory storage device associated with the controller;
(r) determining the clearance of the second mechanical radial back-up bearing as a function of a first diameter determined by the first and second points and a second diameter determined by the third and fourth points; and
(s)repeating steps (b) through (r) for the first radial back-up bearing while maintaining the shaft at a centered position within second radial back-up bearing to determine clearance of the first back-up bearing.

7. The method of claim 6 further including a step of recording the clearance of the mechanical radial back-up bearing determined in step (m).

8. The method of claim 6 further including a step of comparing the clearance of the radial bearing determined in step (m) with a prior recorded determined clearance to determine wear of the mechanical radial back-up bearing.

9. The method of claim 8 wherein the prior, recorded determined clearance of the mechanical radial back-up bearing was a clearance measured and determined when the mechanical safety bearing was new.

10. The method of claim 8 wherein the prior determined clearance is a clearance of the mechanical radial back-up bearing measured and determined from a prior cessation of rotation of the shaft and the wear determination is indicative of the difference in measured clearances during a time interval from the prior cessation of rotation of the shaft to the present measurement.

11. The method of claim 6 wherein the controller is programmable and after the shaft has substantially ceased rotational motion, the steps are performed in accordance with a predetermined sequence by the controller as instructed by the programming means.

12. The method of claim 6 wherein the predetermined angular distance in step (k) is 90°.

13. The method of claim 10 further including a step of comparing the determined wear with a predetermined wear value stored in the controller, and wherein the controller prevents rotation of the shaft when the predetermined wear value is exceeded.

14. The method of claim 10 further including a step of comparing the determined wear with a predetermined wear value stored in the controller, and wherein the controller generates a signal to provide a warning when the predetermined wear value is exceeded.

15. The method of claim 10 wherein the prior determined clearance is a clearance of the mechanical radial back-up bearing measured and determined from a prior cessation of rotation of the shaft, the wear determination is indicative of the difference in measured clearances during a time interval from the prior cessation of rotation of the shaft to the present measurement, and the difference in the wear values during the time interval provides an indication of the wear rate, which wear rate is compared to a predetermined wear rate, and wherein when the wear rate exceeds the predetermined wear rate, the controller generates a signal to provide a warning that the predetermined wear rate is exceeded.

16. The method of claim 1 or 2, further including the following steps:
directing application of electrical power from the controller to the electromagnetic bearings to move the shaft in a first axial direction to a fifth point at which the shaft no longer moves;
determining the position of the fifth point;
providing a signal to the controller indicative of the position of the fifth point;
recording the position of the fifth point in a memory storage device associated with the controller;
then, directing application of electrical power from the controller to the electromagnetic bearings to move the shaft in a second axial direction opposite the first axial direction to a sixth point at which the shaft no longer moves;
determining the position of the sixth point;
providing a signal to the controller indicative of the position of the sixth point;
recording the position of the sixth point in the memory storage device associated with the controller;
determining the clearance of the mechanical axial back-up bearing by determining the distance between the fifth point and the sixth point;
comparing the clearance of the axial bearing with a prior determined clearance stored in the memory storage device associated with the controller to determine wear of the mechanical axial back-up bearing.

17. A rotating apparatus comprising:
a shaft comprising a ferromagnetic material;
active electromagnetic bearings supporting the shaft, the electromagnetic bearings further comprising at least 2 pair of magnetic coils around the shaft and bearing electronics to control the application of current to maintain the shaft at a desired position within the electromagnetic bearings;
a power source to provide power;
a plurality of mechanical back-up bearings to support the shaft when power is removed from the electromagnetic bearings;
position sensors positioned adjacent to each mechanical back-up bearing to determine a position of the shaft and to provide a signal indicative of the shaft position;
power amplifiers to amplify and condition power from the power source and provide power to the magnetic coils;
a programmable controller to modulate current from the power amplifiers to maintain the shaft within a preselected location envelope within the electromagnetic bearings while the shaft is rotating, the controller being programmed to power the electromagnetic bearings to move the shaft in a predetermined sequence to contact at least one mechanical back-up bearing while maintaining the shaft centered within the electromagnetic bearing associated with at least one other mechanical back-up bearing, receive a signal indicative of the shaft position, determine the location of the points of contact of the shaft with the at least one mechanical back-up bearing and determine the clearance of the at least one mechanical back-up bearing.

18. The rotating apparatus of claim 17 wherein the programmable controller further includes a memory storage to store the location of points of contact of the shaft with the mechanical back-up bearings and the clearance of the mechanical back-up bearings.

19. The rotating apparatus of claim 18 wherein the programmable controller further determines wear of the mechanical back-up bearings based on a comparison of measured clearances with stored clearances and prevents operation of the rotating apparatus when a predetermined wear is exceeded.

20. The rotating apparatus of claim 17 wherein the rotating apparatus is a centrifugal compressor.

21. A centrifugal compressor comprising:
a shaft comprising a ferromagnetic material;
active electromagnetic bearings supporting the shaft, the electromagnetic bearings further comprising at least 2 pair of magnetic coils around the shaft and bearing electronics to control the application of current to maintain the shaft at a desired position within the electromagnetic bearings;
a power source to provide power;
a mechanical back-up bearing to support the shaft when power is removed from the electromagnetic bearings;
position sensors to determine a position of the shaft and to provide a signal indicative of the shaft position;
power amplifiers to amplify and condition power from the power source and provide power to the magnetic coils;
a programmable controller in communications with the electromagnetic bearings to modulate current from the power amplifiers to maintain the shaft within a preselected location envelope within the electromagnetic bearings while the shaft is rotating, and wherein, when the shaft is not rotating, the controller is programmed to power the electromagnetic bearings to move the shaft in a sequence to contact the mechanical back-up bearings, receive a signal indicative of the shaft position and to determine the location of the points of contact of the shaft with the mechanical back-up bearings and to determine the clearance of the mechanical back-up bearings.
wherein the programmable controller includes software that performs the sequence of operations set forth in claim 1 after power is restored to the electromagnetic bearings.
